(19) United States
(12) Patent Application Publication
(10) Pub. No.: US 2014/0057242 A1
(43) Pub. Date: Feb. 27, 2014

(54) Personalized Electronic Education

(71) Applicant: Lawrence SHERMAN, Westport, CT (US)

(72) Inventor: Lawrence SHERMAN, Westport, CT (US)

(73) Assignee: GREAT EXPLANATIONS FOUNDATION, Westport, CT (US)

(21) Appl. No.: 13/595,664

(22) Filed: Aug. 27, 2012

(51) Int. Cl. G09B 7/00

(52) U.S. Cl. 434/353

(57) ABSTRACT

In general, in an aspect, embodiments of the invention can provide, a semi- or fully-automatic computer-implemented method for personalized electronic education of a student, the method including, performing a computerized assessment of the student, using a knowledge assessment module, to determine a knowledge deficit of the student associated with at least one concept, defining a learning profile for the student using a learning profile generation module, receiving, at a server module, a computerized explanation submission based on the learning profile, evaluating, using an explanation submission evaluation module of the server module, the received explanation submission based on an understanding of the concept by the student after presentation to the student of the explanation submission, and rating, using the explanation submission evaluation module, the explanation submission based on the evaluation.

### BACKGROUND

Traditional teaching materials such as textbooks are very costly. Teaching materials can also easily become out of date, may be hard or expensive to distribute, and become damaged or worn out. Additionally, writing a textbook is a significant effort that is frequently undertaken by a single or small number of authors, which can result in a limited viewpoint on the subject. Thus, a student may be restricted to a single uniform style of teaching provided by the textbook. In addition, because of the effort involved in writing a textbook as well as the expense, textbooks may not be frequently updated. And, even if the textbook is updated, the new versions may not be purchased frequently.

A single textbook for a subject or concept may force students in a class into the same schedule regardless of their needs. If a student does not understand the single source of explanation for a concept in the textbook, the student may miss the concept and fall behind in the subject. A single textbook also assumes a same level of background by all students using the textbook. Students may be bored and disinterested if a text is too rudimentary, or lost if foundational knowledge, which the student lacks, is omitted from the textbook.

In view of the foregoing, it is apparent that there are significant problems and shortcomings associated with current educational material development and delivery.

### SUMMARY

A system and computer implemented method for generating and delivering personalized electronic education. Techniques can include identifying and dividing a learning concept into a plurality of portions and assessing a student to determine a knowledge deficit of the student associated with the learning concept. The techniques can include defining a learning profile for a student, receiving multiple explanation submissions based on a student's unique learning profile (e.g., for that concept because a student may have a different learning profile for different subjects such as math and language arts), and evaluating one or more of the multiple explanation submissions for each concept portion based on an understanding of the concept by students after presentation of the one or more of the multiple explanation submissions for each concept portion. Evaluation can be performed automatically by gathering feedback of understanding of the concept using a sample of students with a similar learning profile. At least one of the multiple explanation submissions can be identified and ranked based on the evaluation. Explanations can be identified that work for some students with certain learning profiles, but not for those students with other learning profiles. Questions and/or answers can be identified that may work for students with certain learning profiles but not for students with other learning profiles. Answers can be structured and fine-tuned to reveal slight misunderstandings or even the depth of understanding of a concept to allow evaluation and relative ranking of how well students understand a concept (e.g., thus allowing an organization that must interview large numbers of applicants to end up with a more sophisticated ranking of the applicants). Each student can learn at his or her own pace and can see the very best explanation for their learning profile for that particular concept.

A student can select a button on an interface and immediately communicate with a tutor/helper certified for that particular student's learning profile and that concept. The student can also review material as often as he wants and go back and fill-in gaps in his knowledge. All in private and without fear of embarrassment; and with no social or personal pressure. A student can review material as often as they want to fill in gaps in their knowledge.

In general, in an aspect, embodiments of the invention can provide, a semi- or fully-automatic computer-implemented method for personalized electronic education of a student, the method including, performing a computerized assessment of the student, using a knowledge assessment module, to determine a knowledge deficit of the student associated with at least one concept, defining a learning profile for the student using a learning profile generation module, receiving, at a server module, a computerized explanation submission based on the learning profile, evaluating, using an explanation submission evaluation module of the server module, the received explanation submission based on an understanding of the concept by the student after presentation to the student of the explanation submission, and rating, using the explanation submission evaluation module, the explanation submission based on the evaluation.

Implementations of the invention can include one or more of the following features. The explanation is retrieved or received from an available source. The method includes receiving an explanation submission from a pre-qualified or random source. The method includes learning profile information indicative of at least one of prior accumulated knowledge that has been mastered and remembered by the student, a preferred language of the student, a preferred cultural background of the student, a level of interest of the student in a subject, known familiar contexts of the student, an ability of the student to learn new concepts in a particular discipline, a favored style (or styles) of learning of the student, a chronological age of the student, and an academic age of the student. The assessment of the student includes at least one of identifying a priori knowledge for the concept, identifying gaps in a priori knowledge of the student associated with the concept, and supplementing explanation information to address identified knowledge deficits. The method further includes presenting an explanation submission electronically to the student, and synchronizing the electronically presented explanation submission with a lesson plan of the student. The method further includes measuring an understanding of the concept by a plurality of students. The evaluating the explanation submission includes evaluating based at least in part on a number of explanations submitted for a particular concept and a particular learning profile. The method further includes editing the explanation submission prior to evaluating the explanation submission.

In general, in another aspect, embodiments of the invention can provide a computer-implemented method for automatically evaluating electronic education material, the method including receiving, at a server module, electronic explanation submissions of a concept, the electronic explanation submission developed according to a learning profile, presenting, using an explanation submission evaluation module of the server module, the electronic explanation submissions to a first plurality of students, presenting, using an explanation submission evaluation module of the server module, a control electronic explanation of the concept to a second plurality of students, the control electronic explanation developed according to the learning profile, testing the first plurality of students to determine a level of understanding of the concept after presentation of the electronic explanation submission, testing the second plurality of students to determine a level understanding of the concept after presentation of the control electronic explanation, comparing after the testing, using the explanation submission evaluation module, the level of understanding of the concept by the first plurality of students with the level of understanding by the second plurality of students, and rating, using the explanation submission evaluation module, the explanation submission based on the comparison.

Implementations of the invention can include one or more of the following features. The control explanation and the electronic explanation submissions are presented as one of a double-blind test and a blind test. The rating is further based on a popularity of the electronic explanation submission with the first plurality of students. The rating is further based at least in part on a reputation of a source of the electronic education explanation. The method further includes classifying, using the server module, an electronic explanation submission as a verified explanation based upon the rating.

In general, in yet another aspect, embodiments of the invention can provide a system for personalized electronic education including one or more processors communicatively coupled to a network wherein the one or more processors are configured to assess a student to identify a knowledge deficit of the student associated with a concept portion, define a learning profile for the student based on at least one of testing of the student and self-selection, receive an explanation submission based on the learning profile, evaluate the explanation submission based on an understanding of the concept portion by the student after presentation of the explanation submission to the student, and rate the explanation submissions based on the evaluation.

Implementations of the invention can include one or more of the following features. The explanation submission includes receiving a crowdsourced explanation submission. The explanation submission includes receiving an explanation submission from a pre-qualified source. The learning profile includes information indicative of at least one of, prior knowledge of the student, a preferred language of the student, a preferred cultural background of the student, a level of interest of the student in a subject, a known familiar context of the student, an ability of the student to learn new concepts in a particular discipline, a favored style of learning of the student, a chronological age of the student, and an academic age of the student. Assessing the student includes at least one of identifying a priori knowledge for the concept portion, identifying gaps in a priori knowledge of the student associated with the concept or concept portion, and supplementing explanation information to address identified knowledge deficits. The system further includes possibly editing the explanation submission prior to evaluating the explanation submission.

While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE FIGURES

FIG. 1 is an exemplary computer implemented personalized education generation and delivery system.

FIG. 2 is an exemplary portion of the system shown in FIG. 1.

FIG. 3 is an exemplary operational flow chart for a computer implemented personalized education generation and delivery system.

FIG. 4 is an exemplary operational flow chart for a computer implemented personalized education evaluation system.

FIG. 5 is an exemplary operational flow chart for a computer implemented personalized education evaluation system.

### DETAILED DESCRIPTION OF PREFERRED EMBODIMENTS

Embodiments of the invention provide techniques for implementing personalized education generation, evaluation, and delivery. For example, electronic education material can be crowdsourced or outsourced to a group of people for production. Crowdsourcing can be online and/or offline. For example, a subject can be broken down into concepts, and a concept can be broken down into concept portions. A computer system can advertise requests for people (e.g., subject matter experts) to provide explanations and/or education material relating to the subjects, concepts, and/or concept portions (e.g. based on a request from a specific user). Explanation submissions can be received in response to the advertisements and can be evaluated. As discussed in further detail below, the crowdsourcing of explanation submissions and the automatic curation of received explanation submissions can provide electronic education materials that can be personalized by a learning profile of an individual student or group of students. Other embodiments are within the scope of the invention.

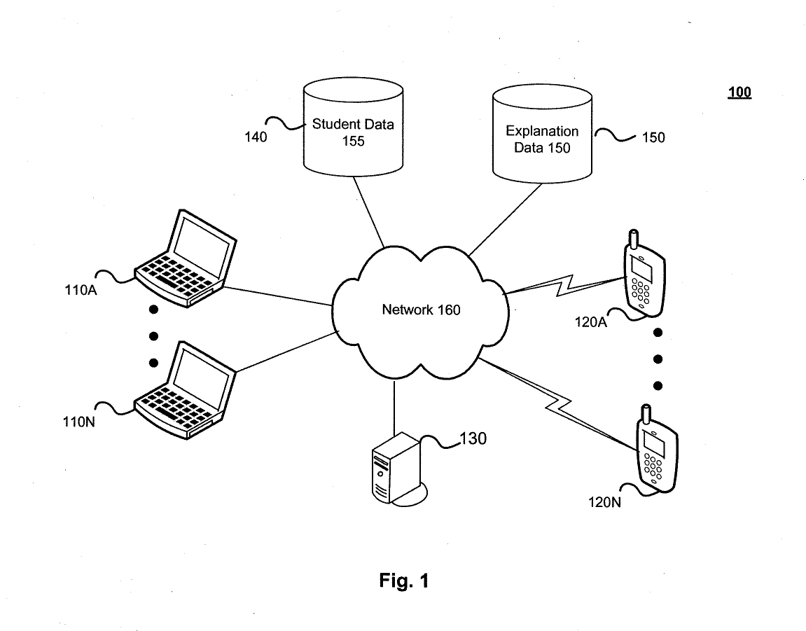

Referring to FIG. 1, an exemplary personalized electronic education system 100 is shown. System 100 can contain client systems 110, 120 and server 130, which can be communicatively coupled to network 160 via a wired and/or wireless network connection. In general, the clients 110A-110N and 120A-120N, and server 130 can include a processor, memory, display device, and operating system software such as Microsoft Windows®, iOS®, Linux, or the like. FIG. 1 is a simplified view of system 100, which can include additional elements that are not depicted such as routers, gateways, servers, etc.

Network 160 can be a local area network (LAN), a wide area network (WAN), the Internet, cellular network, satellite network, or other networks that permit communication between clients 110, 120, server 130, and other devices communicatively coupled to network 160. Network 160 can further include one, or any number, of the exemplary types of networks mentioned above operating as a stand-alone network or in cooperation with each other. Network 160 can utilize one or more protocols of one or more clients or servers to which they are communicatively coupled. Network 160 can translate to or from other protocols to one or more protocols of network devices. Although network 160 is depicted as one network, it should be appreciated that according to one or more embodiments, network 160 can comprise a plurality of interconnected networks.

Electronic Storage 140 and 150 can be network accessible storage and can be local, remote, or a combination thereof to server 130 and clients 110A-110N and 120A-120N. Electronic Storage 140 and 150 can, for example, utilize a redundant array of inexpensive disks (“RAID”), magnetic tape, disk, a storage area network (“SAN”), an internet small computer systems interface (“iSCSI”) SAN, a Fiber Channel SAN, a common Internet File System (“CIFS”), network attached storage (“NAS”), a network file system (“NFS”), optical based storage, or other computer accessible storage. Electronic storage 140 and 150 can also be used for backup or archival purposes.

In some embodiments, clients 110A-110N and 120A-110N, and server 130 can be, for example, smart phones, tablet devices, PDAs, desktop computers, laptop computers, servers, other computers, or other devices coupled via a wireless or wired connection to network 160. Clients 110A-110N and 120A-110N, and 130 can receive data from user input, a database, a file, a web service, and/or an application programming interface.

Server 130 can be an application server, a backup platform, an archival platform, a media server, an email server, a document management platform, an enterprise search server, a combination of one or more of the foregoing, or another platform communicatively coupled to network 160. Server 130 can utilize one or more of electronic storage 140 and 150 for the storage of application data, backup data, or other data. Server 130 can be a host, such as an application server, which can process data traveling between clients 110A-110N and 120A-110N, and other devices communicatively coupled to network 160. In some embodiments, electronic storage 140 and 150 can store personalized electronic education material, learning profile data (e.g., learning profile classifiers), educational statistics, student grades, student test results, one or more algorithms for generating requests for crowdsourced personalized electronic educational material, one or more algorithms for reviewing personalized educational material, one or more algorithms for rating personalized education material, promotional data, tutor data, other student data, and/or other education data.

In some embodiments, server 130 can be a platform used for receiving personalized electronic education material, and/or generating personalized educational material.

Server 130 can also work with various types of systems that are configured to display educational material to students. For example, the server 130 can provide an interface that receives a request for a specific type of explanation in a specific format (e.g., a request for educational material corresponding to a certain learning profile). Continuing the example, server 130 can support a website requesting a puzzle associated with a concept, multiple choice questions focused on the concept and explanatory text discussing the concept.

Learning material (e.g., submitted explanations and/or verified explanations) can be accessible to students in a variety of formats. Clients 110A-110N and 120A-120N can function as electronic textbooks and can be instantly searchable. This can allow a student to find a particular concept they are interested in as well as a corresponding personalized electronic explanation. In some embodiments, Clients 110A-110N and 120A-120N can access material stored locally and network access may not be required. For example, educational material can be periodically downloaded to the Clients 110A-110N and 120A-120N. According to some embodiments, Clients 110A-110N and 120A-120N can access some material stored remotely and network access can be required.

In some embodiments, students can have access to online tutoring. For example, a student having difficulty understanding an explanation can easily and instantly be able to go into a personalized, anonymous, and safe, one-on-one, tutoring center (e.g., hosted by server 130 and presented one or more of clients 110A-110N and 120A-110N). A student can receive prompting, information, or reminders based on a test score or other grading or information can be presented in response a query. A student can be matched-up with a qualified and ranked tutor automatically based on the student's learning profile. Tutoring and coordination to set-up tutoring can be accomplished via crowdsourcing, for example, using e-mail, videoconference, on-line chat, a VOIP based phone call, a social media site (e.g., Facebook™, Twitter™, a proprietary network), or other means. Tutors and students can be evaluated by each other. According to some embodiments, evaluations can be on a grade scale of A to F. Tutors can also be ranked based on subsequent testing of the tutored student on associated educational material. This subjective ranking along with the objective results of the subsequent success or failure by the student of the relevant electronic education material can be used in making future assignments for both the student and the tutor. In some embodiments, evaluations of tutors can be published when the tutor's evaluation exceeds a threshold (e.g., a “B” grade). This ranking can be used to reward successful students and their successful tutors.

For example, tutors can be ranked/measured by: speed with which their students learn, percentage of students who get the answer right the first time after tutoring or with the fewest iterations, and/or happiness rankings from students. Typically, different questions and answers are used so that tutors cannot give the answers away or “teach to the test” to gain higher rankings. By the same token, curators can be ranked/measured by: the speed with which they curate, and/or the accuracy of curation (e.g., false rejections, false approvals). Typically, the system also includes a statistically valid way for other curators in the crowd to double check some of the curations with ties being ruled on by a third curation.

In some embodiments, tutors can be rewarded for the success of their students and student evaluations. Recognition can be on a progressive scale starting with listings, then proceeding to certificates, publicity, and finally awards. An award can include, for example, cash stipends depending on the grades a tutor receives from his or her students, and the number of students that he or she has helped. This can be weighted by the difficulty of the concepts taught, the supply of tutors for a particular concept and learning profile (e.g., how many teach that concept in that format, language, etc.), and other factors. Such recognition can be of great help to highly-ranked tutors when they apply to college or graduate school or teaching positions.

In addition to rewards and recognition for tutors, students can also receive awards and recognition. Recognition can be in the form of online recognition, framed certificates, ribbons, merit badges, trophies, credits, points, levels, access to online educational games, qualification for online educational contests, and other incentives. In some embodiments, parents, guardians, students, and/or schools can approve educational news releases about students that are provided to local media (e.g., a student's or a school's local newspapers or radio stations). A student can have access to a list that provides a summary of educational concepts that a student has learned. The student can filter the list by grade level, date range, subject area, associated tutor, associated teacher, corresponding syllabus subjects, or other criteria. A student can also be able to sort the list. A listing of education concepts learned can be used to provide student rankings (e.g., brown belt, black belt, etc) which can be general, for a grade level, and/or in a subject area. A listing of educational concepts successfully completed by a student can also be used to provide recommendations of additional educational concepts, eligibility for scholarships, qualification for internships, qualification for recommendations, eligibility to tutor certain subject areas, and other benefits.

Development of incentives, such as games, fun educational facts, or other awards can also be crowdsourced. Requests for educational games, fun facts, or other educational incentives for certain subjects, concepts, and/or learning profiles can be posted to a website, requested via email, or otherwise electronically crowdsourced. Received incentives can be screened, tested, approved, and rated. Incentives can be rated by popularity based on incentive recipient feedback or the number of requests for a particular incentive. More popular incentives can require greater educational achievement to obtain. For example, more popular games can require review and successful testing on a higher number of explanations than a less demanded incentive.

By crowdsourcing electronic educational materials, targeting the materials by learning profile, and reducing and/or eliminating the need for manual review and processing of educational materials, several benefits can be realized. Educational materials can be provided to a far greater number of people, and to more different types of people, educational materials can be made available in a wider range of subject areas, the cost of educational materials can be significantly lowered, educational materials can be more effective based on teaching styles being matched to a learning profile, and educational materials can be refreshed more frequently. Many other benefits can be realized.

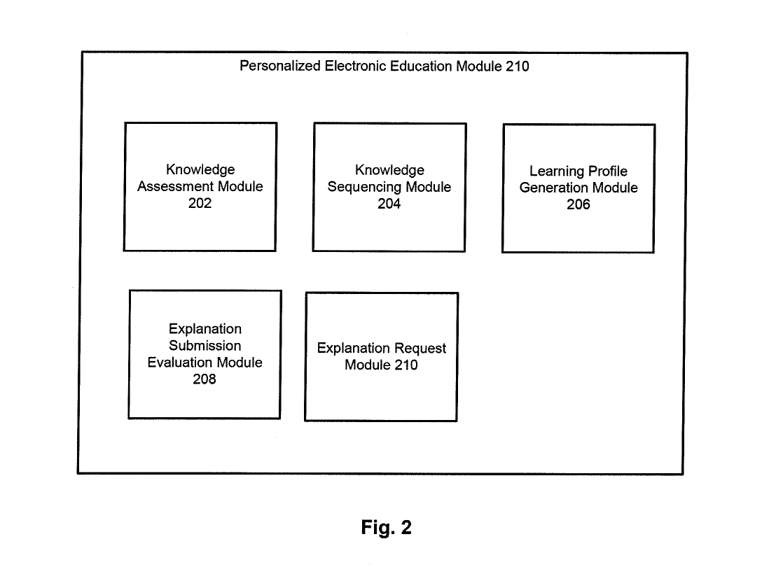

Referring to FIG. 2, a personalized electronic education module 210 is shown. As illustrated, the personalized electronic education module 210 includes knowledge assessment module 202, knowledge sequencing module 204, learning profile generation module 206, explanation submission evaluation module 208, and explanation request module 210. The personalized electronic education module 210 is exemplary, and can include more modules and/or certain described modules can be omitted. One or more modules of FIG. 2 can be implemented on server 130, one or more of clients 110A-110N, one or more of clients 120A-120N, or a combination of the foregoing.

The description below describes network elements, computers, and/or components of a system and method for generating personalized electronic education material that can include one or more modules. As used herein, the term “module” is understood to refer to computing software, firmware, hardware, and/or various combinations thereof. Modules, however, are not to be interpreted as software that is not implemented on hardware, firmware, or recorded on a non-transitory processor readable recordable storage medium (i.e., modules are not software per se). It is noted that the modules are exemplary. The modules can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

Knowledge assessment module 202 can evaluate a student's (or even a teacher's) level of knowledge prior to presenting electronic educational material such as a submitted explanation or verified explanation. According to one or more embodiments, pre-testing can be performed to determine a student's level of knowledge prior to presenting explanations. For example, there can be a short, multiple-choice test to test a student's “knowledge-deficit” with respect to a particular problem. That is, the student may already know this concept or may require a pre-requisite learning concept. If a student does not understand a concept, it can be useful for the student to recognize what he or she does not know so that it will be appreciated later. Also, determining a student's understanding of a concept and whether the student learned the subject from the educational material presented to the student or if the student knew it already can be accomplished. For example, a pre-test can have one or two multiple-choice questions each with four multiple-choice answers, three of which are wrong answers, but each of which would appear to be the correct answer if the student had a particular typical misunderstanding of the solution to this particular problem. This process can take advantage of the fact that there are typical misunderstandings or wrong “forks in the road” where people who do not understand a problem generally go wrong. This process can also be used over time to track the student's progression towards mastery of a concept. Knowledge assessment module 202 can provide an indicator of a student's prior knowledge of a concept when subsequently rating electronic education materials for that concept.

Knowledge sequencing module 204 can synchronize presentation of electronic education materials based on alignment with a student's syllabus, a student's prior knowledge, a student's learning profile, and other factors. For example, knowledge sequencing module 204 can suggest or require pre-requisite learning concepts prior to presenting an education concept. Knowledge sequencing module 204 can also evaluate one or more test results or grades to identify subsequent learning concepts for a particular student to learn.

Learning profile generation module 206 can receive, generate, request, and/or detect learning profiles for students. Student learning profiles can indicate, for example, a student's background, cultural preference, language, chronological age, academic age, gap in knowledge, contextual experiences, interests, ability-to-learn, desire-to-learn, favorite style of learning, and currently remembered and mentally-accessible prior knowledge. A student's learning profile can also include a student's favored or most successful method or style of learning (e.g., reading, viewing, listening, cartoons, graphics, text, diagrams, tactile, audible, analogies, pictures, videos, demonstrations, etc.). Student learning profiles can further include other indicators used to tailor electronic educational material development and delivery. Although a student can initially select a student learning profile based on preference, learning profile generation module 206 can learn over time what is effective for that particular student (e.g., based on one or more test results associated with material presented to a student). Learning profile generation module 206 can periodically suggest to the student an updated learning profile. Learning profile generation module 206 can offer a pre-test to help each student initially to identify which learning profiles likely will work best to help that particular student with respect to each subject area.

Learning profiles can be classified broadly and can be adjusted based on testing results, administration preferences, teacher preferences, student preferences, or other factors. For example, learning profiles can be based generally on a grade level or chronological age and can be refined based on data indicating different learning styles and levels of success with different types of educational materials. In some embodiments, the number of available learning profiles can be limited to a predefined number (e.g., 500). It can be more effective to have a limited number of learning profiles that all students are “mapped” to rather than having each student assigned a unique learning profile. For example, it may be better to assign a student a learning profile that matches the student 90%, and have fewer learning profiles to develop educational material for, than to have a learning profile that fits a student 100%, but have a potentially infinite number of learning profiles to develop educational material for.

Although a student can initially select a student learning profile based on preference, learning profile generation module 206 can learn over time what learning profile is most effective for that particular student (e.g., based on one or more test results associated with material presented to a student) at that point in their life and for that particular subject area, such as music, social studies, and/or math. A student's learning profile may change over time. Learning profile generation module 206 can periodically suggest to the student an updated learning profile. Learning profile generation module 206 can even offer a pre-test to help each student initially to identify which learning profile likely will work best to help that particular student at that moment in the student's life and for that particular subject area.

Learning profile generation module 206 can periodically reevaluate learning profiles of students. Electronic storage can store statistics relating to what types of electronic explanations work well for each particular learning profile and what each student has learned so far (e.g., electronic storage 140 and/or 150 of FIG. 1). Each subsequent electronic explanation presented to a student can be iteratively improved to match the best and latest learning profile for that particular, individual student.

Explanation submission evaluation module 208 can receive submitted explanations.

Explanations can be received via one or more electronic transmissions including, but not limited to: e-mails, HTTP transmissions, FTP transmissions, SMS messages, etc. Submitted explanations can be parsed, filtered for prohibited terms (e.g., profanity), screened for required concept terms, scored, ranked, spell checked, or otherwise processed. Received electronic educational materials can be iteratively processed, screened, modified, tested, and/or selected. For example, the explanation submission evaluation module 208 can receive an e-mail containing educational information relating to calculus, which is then screened and scored before it is made available to students. The submitted, and thus automatically vetted explanations can then be presented in a blind manner to students as was described above, and/or can be manually vetted by the crowd before being submitted to a statistically valid sample of like learning profile students for testing to see which explanation is the best for students with that learning profile. Submitted explanations can be categorized by concept, concept portion, and/or learning profile. Submitted explanations can be iteratively automatically or manually processed, screened, modified, tested, and/or selected for the ultimate goal of arriving at a verified explanation that can be presented to students with confidence. According to one or more embodiments, submitted explanations can be received, processed, and submitted for testing without human intervention.

Explanation submission evaluation module 208 can also receive submitted explanations from, for example, students, the public, and/or another predetermined group of people. Submitted explanations can include material from third-party sources. A submitter does not have to be the author of the material, but proper attribution should be provided by a submitter if they are not the author. For example, so that a submitter still can receive credit for a submission. An original author can receive credit as well. For example, a submitter can submit online educational material from a well-known educational institution and can properly indicate the source of the material (e.g., Joe Q. Public submits a link to an on-line Harvard University lecture). Permission to use a submitted explanation for which authorship is or is not attributed to the submitter can be verified prior to use. Original authors can also receive credit, incentives, rewards, and/or compensation.

Explanation submission evaluation module 208 can automatically check submitted explanations for, for example, accuracy, ease of understanding, completeness, and lack of ambiguity. For example, in some embodiments, Explanation submission evaluation module 208 can be provided with a set of keywords, phrases, formulas, facts, or other criteria to search for in a submitted explanation for a concept. Presence or absence of the criteria can provide a first level of vetting or curating of a submitted explanation. For example, key concept terms and synonyms for key concept terms can be parsed from a syllabus, lesson plan, or other education schedule that a submitted explanation is to be synchronized with. According to some embodiments, a person requesting an explanation can provide a set of criteria for a first level of vetting of submitted explanations.

According to some embodiments, submitted explanations can also be reviewed by experts in a field or subject matter area of a concept. Submitted explanations can be electronically provided to one or more certified curators for the subject matter area of a concept (e.g., posted to a secured website or a distributed via a limited mailing list.) Crowdsourcing of curation of submitted explanations can allow submitted explanations to be reviewed by a wider range of people including a wider range of languages and cultures. This can allow explanations to be provided for a greater number of people, a greater range of student demographic backgrounds, and a greater range of learning profiles. Edited and/or revised submitted explanations can be received by explanation submission evaluation module 208. According to some embodiments, submitted explanations can be rejected and/or returned to a submitter after a review by a certified curator with a request for clarification or other edits.

Submitted explanations can be tested by a sample group of test students prior to being presented to a larger group of students. Testing can present submitted explanations as a blind extra (or third) explanation to a small but statistically significant number of students, to test that explanation against a current standard (or “Control”) for a particular concept to be learned by students with the same target learning profile. The control standard can be a vetted or certified explanation that has been reviewed by experts, proven successful based on prior student test scores (possibly including the time required for students to learn a concept), proven popular with students, and/or authored by an established expert for the learning concept. Students who unknowingly are testing unproven explanations also can get additional certified explanations to ensure that a student is not limited to an uncertified explanation.

To avoid test bias, the presentation order of the contending unproven submitted explanation and the currently high-ranking certified explanation (the “control”) can be randomly alternated from student to student. Less well performing explanations (new or old) can be abandoned in a selection process that allows more successful explanations to succeed. Even certified or vetted explanations can be periodically reevaluated and/or ranked against other explanations. Testing can be random, immediate, or automatically scheduled and conducted. For example, submitted explanations can be presented to a set of test students automatically by sending an electronic invitation, calendar notification, email, or other communication. The communication can contain a link to an online test. Questions associated with the submitted explanations can be incorporated into an online test together with control questions. The questions can be provided by a submitter of the explanation being tested or by another submitter.

For each explanation, percentages of students who comprehend a concept within various time frames or within various numbers of reviews of the material can be tracked. This can indicate which explanations seem to be the easiest and/or quickest to understand with respect to each concept or concept portion and learning profile, which concepts are difficult, what prerequisites are required and how the syllabus might be re-ordered to eliminate gaps and/or to be more intuitive. Test results of a submitted explanation can be published (e.g., without student identifying information) so that electronic education contributors and/or authors can identify areas of greatest need, and/or study what types of explanations work best, and for which learning profiles. Ratings and/or feedback relating to the electronic education materials can be provided by students to allow identification of electronic education materials that require improvement and/or electronic education materials that are well liked. Ratings and/or feedback can be provided, for example, electronically via a provided website, in response to an email, in response to questions provided after an explanation, or via more traditional survey or questionnaire methods.

In some embodiments, several, or any number of submitted explanations for the same topic (or even different topics) can be compared against one another to determine which one is best for a given student and/or learning profile (e.g., certain submitted explanations may be suitable for visual learners, but not hands-on learners). For example, several submitted explanations (or verified explanations) for a particular concept can be presented to a group of students. The students can then be tested on that concept (e.g., as described in the previous paragraph), and the explanation submission evaluation module 208 can track how effective each respective explanation was in educating the student. By tracking this information, the explanations can be ranked against one another. The ability to measure the extent to which one explanation is better than all others for a particular concept and learning profile can be determined by many factors such as the number of explanations competing to explain a particular concept for students with a particular learning profile, and/or the number of students testing each explanation, and/or the difference in measurable results between one explanation and its closest competitor. A confidence rating can be assigned to each verified explanation to indicate how likely it is that that explanation is indeed the best for that concept and that learning profile

Submitted explanations that fail to facilitate student understanding and passage of a subsequent test can automatically be discarded in favor of explanations that have been proven by previous students' test scores to work better (e.g., an explanation scores higher for a particular concept and learning profile). Explanation submission evaluation module 208 can measure and rank the time that it takes a student to get the correct answer after first seeing an explanation. Additionally, even if the student correctly and quickly answers a test based on an explanation, the student can rate the explanation. Ratings can include whether it was fun and easy to learn, or confusing, tedious or otherwise irritating. Rating systems can include, for example, three “thumbs-up,” or two “thumbs-down,” numerical rankings, and/or other indicators. The ranking process can facilitate selection of the best explanations for each concept in each learning profile, an understanding of which learning profiles work best for each student for each of their subjects. This can allow subsequent automatic offerings of explanations that are targeted to students with the same learning profiles.

In some embodiments, a concept can be taught using explanations from multiple different contributors. For example, explanation submission evaluation module 208 can receive text and diagrams from a first contributor for a particular concept and can receive testing material and answers from a second contributor for the same concept. Explanation submission evaluation module 208 can combine the contributions from the various sources to create a single cohesive information source. Also, explanations, questions, and answers associated with a single concept and a single learning profile can each be obtained from separate submitters. Although a particular submitter may provide a best explanation, a second submitter may provide better questions to test understanding, and a third submitter may provide the best answers to the questions to test understanding. Questions and answers can be evaluated separately in a manner similar to explanations (e.g., based on blind testing).

Different contributors can also provide a lab for a concept, explanatory text discussing the concept, and a video for the concept. Explanation submission evaluation module 208 can test different submitted explanations and can combine some and/or omit others based on test results. According to some embodiments, when an explanation for a concept is requested it can contain an indication of types of materials requested which can be based on a learning profile (e.g., a presentation video, a puzzle, a lab, testing materials, study guides, games, etc.) Different contributors can work separately or collaboratively to produce the materials.

Explanation submission evaluation module 208 can also rank explanations based on their fit within a learning profile for a student (e.g., a student's background, cultural preference, language, chronological age, academic age, gap in knowledge, contextual experiences, interests, ability-to-learn, desire-to-learn, favorite style of learning, currently remembered and mentally-accessible prior knowledge, and a student's favored or most successful method or style of learning).

Explanation request module 210 can request electronic education materials by posting on a website, sending e-mails, a tweeting, sending Short Message Service (SMS) messages, and/or via other electronic transmission mediums. One or more templates for requests, algorithms for generating requests, student learning profiles, and other electronic education request material can be retrieved by explanation request module 210 from electronic storage. For example, the explanation request module 210 can post a request on a webpage asking for subject matter experts in the area of calculus to submit educational materials relating to specific calculus concepts and specific learning profiles.

In some embodiments, explanation request module 210 can be used to transmit requests for electronic education materials. For example, explanation request module 210 can be a web server or an application server posting or transmitting a request to the public for personalized educational material explaining an educational concept (e.g., server 130 of FIG. 1). The educational material request can be directed to the public at large, or to a predetermined group. The educational material request can also specify a targeted learning profile, format guidelines or requirements, desired subject matter coverage, required subject matter coverage or other details. Requested electronic educational material can include information for synchronization with a study plan, syllabus, or other educational schedule of a student or group of students. For example, concepts can be broken into one or more portions so as to synchronize with a class lesson plan or to be easier to understand.

Requested electronic educational materials can also be targeted by a student learning profile.

Explanation request module 210 can request electronic education materials by posting on a website, sending email, a tweet, a Short Message Service (SMS) message, or via another electronic transmission. One or more templates for requests, algorithms for generating requests, student learning profiles, and other electronic education request material can be retrieved by explanation request module 210 from electronic storage (e.g., electronic storage 140 and/or 150 of FIG. 1).

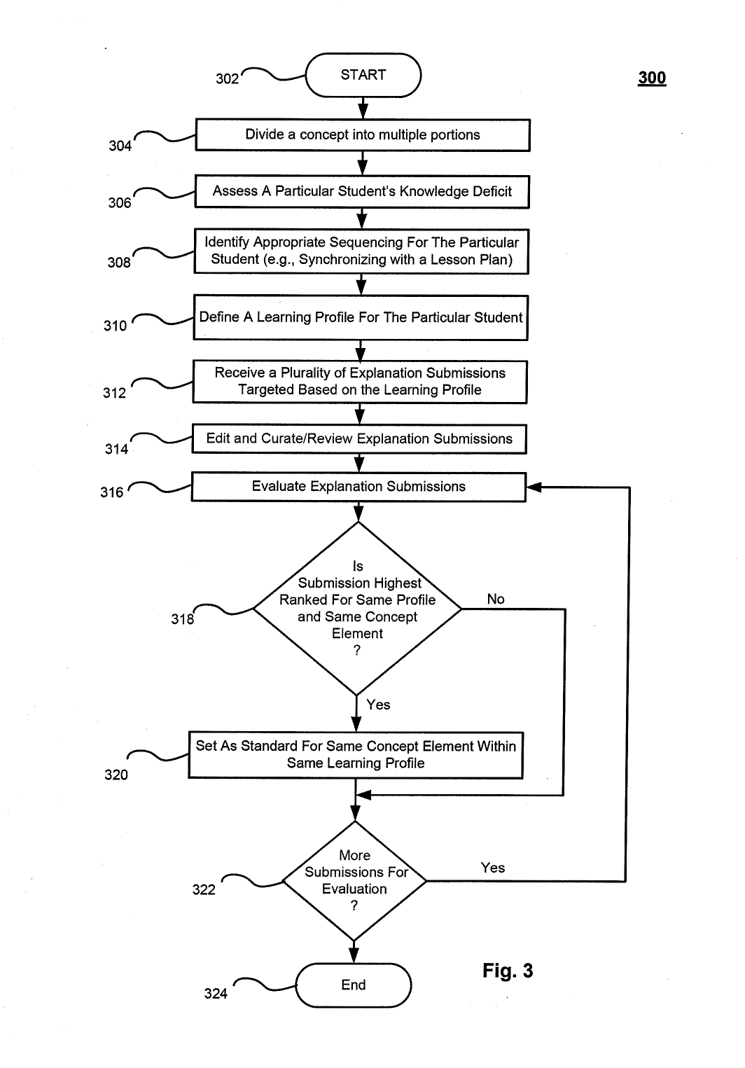

In operation, referring to FIG. 3, with further reference to FIGS. 1-2, a method 300 for generating and evaluating personalized education using the system 100 can include the stages shown. The method 300, however, is exemplary only and not limiting. The process 300 can be altered, e.g., by having stages added, changed, removed, or rearranged.

At stage 302, the method 300 can begin.

At stage 304, a learning concept can be divided into multiple portions. This can be based on organization of a learning concept found in a student's syllabus. Division of a learning concept can also be performed to allow introduction of prerequisite material prior to one or more portions, or to match a learning profile of a student. For example, if a student is being taught calculus, the concepts can be broken down such that a student is first taught differential calculus and then integral calculus, and each of those concepts can be broken down into further sub-units of information, and so on, until a concept is no longer sensibly divisible for effective learning.

At stage 306, a particular student's learning deficit can be assessed. For example, knowledge assessment module 202 of FIG. 2 can assess a student's learning deficit. A learning deficit can be assessed using a pre-test to establish a student's existing knowledge of a concept. A student can also be presented with a series of questions that have difficulty levels ranging from basic to advanced. In addition, the students can also be presented with questions that are designed to probe specific areas of the student's knowledge. For example, a student can be tested to ensure that the student has a solid understanding of trigonometry before the student begins to learn calculus.

At stage 308, appropriate sequencing for a particular student can be determined. For example, knowledge sequencing module 204 of FIG. 2 can determine sequencing of educational material. This can allow electronic education material for that student to follow a lesson plan or syllabus for the student. It can also allow introduction of additional preparation materials, review, tutoring, or additional related student interest areas. For example, based upon the student's knowledge level or learning profile, the sequencing of a lesson presented to the student can be modified (e.g., the student is taught trigonometry before being taught calculus).

At stage 310, a learning profile can be defined for a student. For example, learning profile generation module 206 of FIG. 2 can define a student's learning profile. Student learning profiles can indicate, for example, a student's background, cultural preference, language, chronological age, academic age, subject related gaps in knowledge, contextual experiences, interests, ability-to-learn, desire-to-learn, favorite style of learning, and currently remembered and mentally-accessible prior knowledge. Student learning profiles can also include a student's favored or most successful method or profile of learning (e.g., reading, viewing, listening, cartoons, graphics, text, diagrams, tactile, audible, analogies, pictures, videos, demonstrations, etc.). Student learning profiles can further include other indicators used to tailor electronic educational material development and delivery. According to some embodiments, a pre-test can be used to initially identify which learning profiles can work best to help a particular student in each subject area.

At stage 312, submissions including educational materials can be received. The submissions and/or educational material can be targeted to a student's learning profile, or be generic for use with a large group of students. Submissions can be received via one or more electronic transmissions including, but not limited to: e-mails, HTTP transmissions, FTP transmissions, SMS messages, etc. For example, subject matter experts can view a student's individualized lesson plan, and provide educational materials targeted for that particular student.

At stage 314, received submissions can be edited and reviewed to, for example, parse and/or filter the submitted explanations for prohibited terms (e.g., profanity). For example, explanation submission evaluation module 208 of FIG. 2 can receive and process submissions. The received submissions can also be screened for required concept terms, scored, ranked, spell checked, or otherwise processed. The processing performed on the received submissions can also be iterative (e.g., iteratively processed, screened, modified, tested, and/or selected).

At stage 316, received submissions including education materials can be further evaluated. For example, explanation submission evaluation module 208 of FIG. 2 can evaluate and rate submissions. The received submissions can be tested by a sample group of test students prior to being presented to a larger group of students. Testing can present electronic education submissions as a blind extra (or third) explanation to a small but statistically significant number of students, to test that explanation against a current standard (or “Control”) for a particular concept to be learned by students who share a particular set of learning styles and/or learning profile. Testing can be automatically scheduled and conducted. For example, electronic education submissions can be presented to a set of test students. Questions associated with the electronic education submissions can be incorporated into an online test together with control questions. For each explanation, a percentage of students who comprehend a concept within a specified time frame or within a specified number of reviews of the material can be tracked. This can indicate which concepts are difficult, what prerequisites are required, and how the syllabus might be re-ordered to eliminate gaps and/or to be more intuitive.

At block 318, the process 300 determines if a received submission is ranked the highest for teaching students with a particular set of learning profiles a learning concept or portion of a learning concept. If a submission is ranked the highest for teaching students with a particular learning profile a learning concept, or portion of a learning concept, the method continues to stage 320. Otherwise, the method 300 continues to stage 322.

At stage 320, a highest ranked submission can be set as a standard for teaching a particular learning concept or portion of a learning concept to students with particular set of learning profiles. A highest ranked submission can become a control explanation for evaluation of other explanations.

At stage 322, the method 300 determines whether more submissions are to be evaluated. If more submissions are to be evaluated, the method 300 returns to block 316, otherwise the process proceeds to stage 324.

At stage 324, the method 300 can end, if desired.

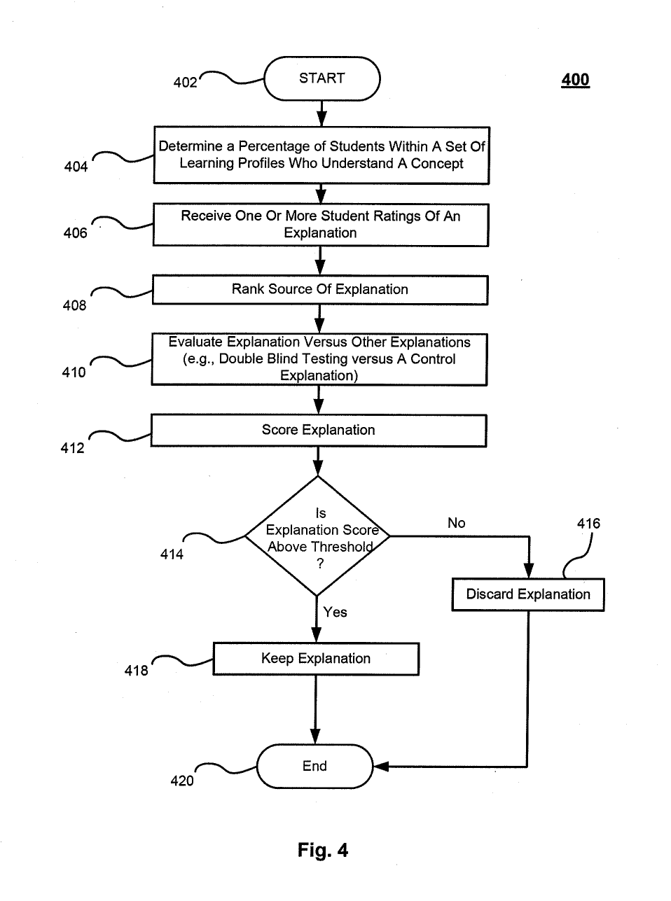

In operation, referring to FIG. 4, with further reference to FIGS. 1-2, a method 400 for evaluating personalized education using the system 100 includes the stages shown. The method 400, however, is exemplary only and not limiting. The method 400 can be altered, e.g., by having stages added, removed, changed, or rearranged According to one or more embodiments, explanation submission evaluation module 208 of FIG. 2 can perform processing associated with one or more of the stages shown in FIG. 4. In some embodiments, portions of processing can be performed on a client side (e.g., clients 110A-110N and 120A-120N of FIG. 1) or one or more other modules.

At stage 402, the method 400 can begin.

At stage 404, a percentage of students within a particular learning profile who understand a concept can be measured. For example, in order to do so, test results associated with explanations can be evaluated. For each explanation a percentage of students who comprehend a concept within a specified time frame or within a specified number of reviews of the material can be tracked. This can indicate which concepts are difficult, what prerequisites are required, and how the syllabus might be re-ordered to eliminate gaps and/or to be more intuitive.

At stage 406, one or more student reviews can be received. The reviews can include ratings that relate to one or more different quantifiable and/or subjective aspects of the educational material. For example, ratings can include whether it was fun and easy to learn, or confusing, tedious or otherwise irritating. Rating systems can include, for example, three “thumbs-up,” or two “thumbs-down,” numerical rankings, and/or other indicators. This rating process can facilitate selection of explanations as well as determination of what categories, in general, of explanations seem to work best for each type of specific student. This can allow automatic offering of subsequent categories of explanations that are tailored to a particular student.

At stage 408, a source of a certified explanation can be evaluated. This can be based on student ratings for an explanation being evaluated, how much better this particular explanation scored compared to the second best explanation or second place winner, how scarce explanations are for that particular concept and learning profile, how many best or certified explanations that particular author has submitted, ratings of a plurality of explanations written by the source, reviews of the source, or other factors.

At stage 410, testing can present submitted explanations as a blind extra (or third) explanation to a small but statistically significant number of students, to test that explanation against a current standard (or “Control”) for a particular concept to be learned by students who share a learning profile. Testing can be automatically scheduled and conducted. For example, submitted explanations can be presented to a set of test students. Questions associated with the submitted explanations can be incorporated into an online test together with control questions.

At stage 412, an explanation can be scored based on test results, source evaluations, student evaluations, and other factors.

At stage 414, it can be determined whether the score for an explanation is above a specified threshold. If the score for an explanation is above a specified threshold, the method continues to stage 418. Otherwise, the method proceeds to stage 416.

At stage 416, explanations that do not have a score above the threshold can be discarded, stored, and/or marked for further evaluation or refinement.

At stage 418, an explanation with a score above a specified threshold can be saved as a certified explanation for future use. According to some embodiments, prior to certifying an explanation against a current best explanation for a particular concept and learning profile, the explanation can be reviewed by specified experts for the subject matter of the concept.

At block 420, the method 400 can end.

In some embodiments, the system can be configured to guard against submitters of explanations, consciously or unconsciously, forcing or biasing students towards the correct answer, thus making it appear that their questions, answers, and/or explanations are better than they really are (thus consequently causing their explanation to outperform the other explanations against which it is competing). For example, this could occur if the submitter “teaches to the test,” and/or writes questions and answers in such a way that most students naturally would pick the correct answer, even when they do not fully understand the concept. As one method of guarding against submitters from gaming the system by submitting biased questions and answers, the questions and answers can also be tested in the same way as is each submitted explanation (e.g., by crowdsourcing the questions and answers to be tested).

For example, to maintain high quality, effective questions and answers (e.g., used to test a student's knowledge level), the system can be configured to: i) use questions and answers derived independently of the submitter for each concept and learning profile, ii) use different, statistically valid, randomly assigned, “non-paired” questions and answers for each concept and learning profile in order to statistically identify testing aberrations introduced by poor questions and/or answers, and iii) use crowdsourced volunteers to randomly check some or all winning verified explanations to ensure that the questions and answers are of high quality. “Non-paired” in this context means that the system can be configured to split-up each question and its supplied three wrong and one right answers, and then take the now free-floating question and these now free-floating answers and randomly mix and match them with other free-floating questions and other free-floating answers in different combinations (but typically only for the same concept and the same learning profile).

In some embodiments the system can also be configured to guard against students selecting the correct answer by chance or with help from others (e.g., by identifying students whose recurring test results suggest guessing or receiving from others correct answers).

In some embodiments, teachers and school districts can insert their own questions and answers for any concept and learning profile, or specify which “standard” test questions and answers a teacher or school board wants to be used for their students. Teacher-written and industry-standard questions and answers can also be tested to see if some should be used on a more widespread basis.

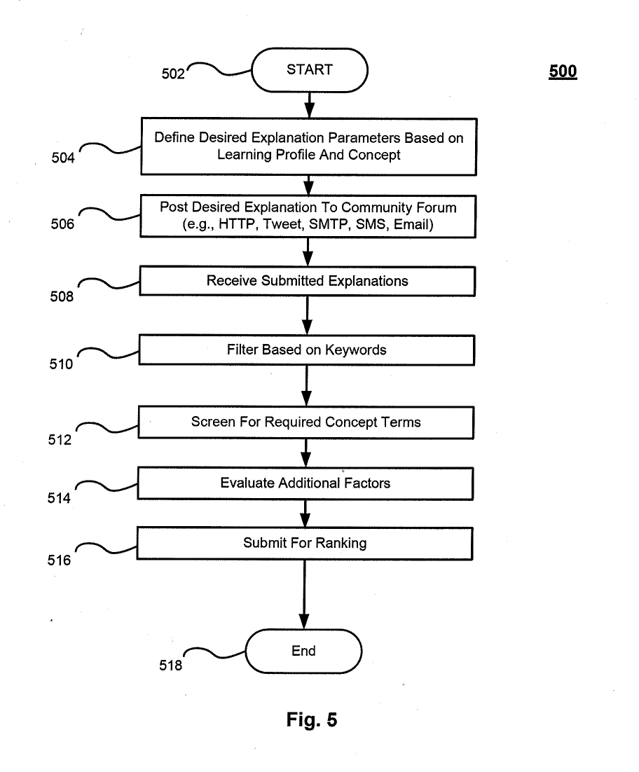

In operation, referring to FIG. 5, with further reference to FIGS. 1-2, a method 500 for requesting and pre-processing of submissions for personalized education using the system 100 includes the stages shown. The method 500, however, is exemplary only and not limiting. The method 500 can be altered, e.g., by having stages added, removed, changed, or rearranged. According to one or more embodiments, explanation request module 210 of FIG. 2 can perform processing associated with one or more of the stages shown in FIG. 5. According to one or more embodiments, explanation submission evaluation module 208 of FIG. 2 can perform processing associated with one or more of the stages shown in FIG. 5. In some embodiments, portions of processing can be performed on a client side (e.g., clients 110A-110N and 120A-120N of FIG. 1) or one or more other modules.

At stage 502, the method 500 can begin.

At stage 504, parameters of a desired submission can be defined. For example, a desired submission can be electronic educational material drafted to explain a particular concept for a particular learning profile. Parameters can include elements and key terms of a concept that should be covered. A lesson plan or other curriculum can be parsed to identify key terms of a concept. Elements of a learning profile can be extracted to identify a target audience for the desired submission. For example, learning profile concepts specified can include: prior knowledge of the student, a preferred language of the student, a preferred cultural background of the student, a level of interest of the student in a subject, a known familiar context of the student, an ability of the student to learn new concepts in a particular discipline, a favored style of learning of the student, a chronological age of the student, and an academic age of the student. According to one or more embodiments, explanation submission evaluation module 208 of FIG. 2 can provide a user interface for receiving and transmitting requested explanation parameters.

At stage 506, a request for a desired explanation can be submitted. Explanations can be requested via one or more electronic transmissions including, but not limited to: e-mails, HTTP transmissions, FTP transmissions, tweets, SMS messages, etc. Posting of a desired explanation can provide crowdsourcing of the explanation generation.

At stage 508, submissions including educational materials can be received. The submissions and/or educational material can be targeted to a student's learning profile, or be generic for use with a large group of students. Submissions can be received via one or more electronic transmissions including, but not limited to: e-mails, HTTP transmissions, FTP transmissions, SMS messages, etc. For example, subject matter experts can view a student's individualized lesson plan, and provide educational materials targeted for that particular student.

At stages 510, 512 and 514, received submissions can be edited and reviewed to, for example, parse and/or filter the submitted explanations for prohibited terms (e.g., profanity). For example, explanation submission evaluation module 208 of FIG. 2 can receive and process submissions. The received submissions can also be screened for required concept terms, scored, ranked, spell checked, or otherwise processed. The processing performed on the received submissions can also be iterative (e.g., iteratively processed, screened, modified, tested, and/or selected). Additional factors can include considerations such as a number of explanations for a particular concept and a particular learning profile. For example, if a preferred language has only one explanation for a concept it is far less likely that such an explanation would be filtered out.

At stage 516, a submitted explanation can be submitted for ranking. As described above in reference to FIG. 4., ranking can include testing by a control group of students.

While the description discusses “concepts,” the techniques described herein can also be used with subjects and/or concept portions.

Other embodiments are within the scope and spirit of the invention.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other input devices can be included, such as a virtual keyboard or a key pad created on a touch screen, a joystick, a stylus, and a pen. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Further, while the description above refers to the invention, the description may include more than one invention.

1. A computer-implemented method for personalized electronic education of a student, the method comprising:
performing a computerized assessment of the student, using a knowledge assessment module, to determine a knowledge deficit of the student associated with at least one concept;
defining a computerized learning profile for the student using a learning profile generation module;
receiving, at a server module, a computerized explanation submission based on the learning profile;
evaluating, using an explanation submission evaluation module of the server module, the received explanation submission based on an understanding of the concept by the student after presentation to the student of the explanation submission; and
rating, using the explanation submission evaluation module, the explanation submission based on the evaluation.

2. The method of claim 1, wherein the explanation is retrieved from an available source.

3. The method of claim 1, wherein receiving the explanation submission includes receiving an explanation submission from a pre-qualified source.

4. The method of claim 1, wherein the learning profile includes information indicative of at least one of:
prior knowledge of the student;
a preferred language of the student;
a preferred cultural background of the student;
a level of interest of the student in a subject;
a known familiar context of the student;
an ability of the student to learn new concepts in a particular discipline;
a favored style of learning of the student;
a chronological age of the student; and
an academic age of the student.

5. The method of claim 1, wherein performing an assessment of the student includes at least one of:
identifying a priori knowledge for the concept;
identifying gaps in a priori knowledge of the student associated with the concept; and
supplementing explanation information to address identified knowledge deficits.

6. The method of claim 1, further comprising:
presenting an explanation submission electronically to the student; and
synchronizing the electronically presented explanation submission with a lesson plan of the student.

7. The method of claim 1, further comprising measuring an understanding of the concept by a plurality of students.

8. The method of claim 1, wherein evaluating the explanation submission includes evaluating based at least in part on a number of explanations submitted for a particular concept and a particular learning profile.

9. The method of claim 1, further comprising editing the explanation submission prior to evaluating the explanation submission.

10. A computer-implemented method for automatically evaluating electronic education material, the method comprising:
receiving, at a server module, electronic explanation submissions of a concept, the electronic explanation submission developed according to a learning profile;
presenting, using an explanation submission evaluation module of the server module, the electronic explanation submissions to a first plurality of students;
presenting, using the explanation submission evaluation module, a control electronic explanation of the concept to a second plurality of students, the control electronic explanation developed according to the learning profile;
testing the first plurality of students to determine a level of understanding of the concept after presentation of the electronic explanation submission;
testing the second plurality of students to determine a level understanding of the concept after presentation of the control electronic explanation;
comparing after the testing, using the explanation submission evaluation module, the level of understanding of the concept by the first plurality of students with the level of understanding by the second plurality of students; and
rating, using the explanation submission evaluation module, the explanation submission based on the comparison.

11. The computer-implemented method of claim 11, wherein the control explanation and the electronic explanation submissions are presented as one of a double-blind test and a blind test.

12. The computer-implemented method of claim 11, wherein the rating is further based on a popularity of the electronic explanation submission with the first plurality of students.

13. The computer-implemented method of claim 11, wherein the rating is further based at least in part on a reputation of a source of the electronic education explanation.

14. The computer-implemented method of claim 11 further comprising classifying, using the server module, an electronic explanation submission as a verified explanation based upon the rating.

15. A system for personalized electronic education comprising:
one or more processors communicatively coupled to a network wherein the one or more processors are configured to:
assess a student to identify a knowledge deficit of the student associated with a concept portion;
define a learning profile for the student based on at least one of testing of the student and self-selection;
receive an explanation submission based on the learning profile;
evaluate the explanation submission, using an explanation submission evaluation module, based on an understanding of the concept portion by the student after presentation of the explanation submission to the student; and
rate the explanation submission, using the explanation submission evaluation module, based on the evaluation.

16. The system of claim 15, wherein receiving the explanation submission includes receiving a crowdsourced explanation submission.

17. The system of claim 15, wherein receiving the explanation submission includes receiving an explanation submission from a pre-qualified source.

18. The system of claim 15, wherein the learning profile includes information indicative of at least one of:
prior knowledge of the student;
a preferred language of the student;
a preferred cultural background of the student;
a level of interest of the student in a subject;
a known familiar context of the student;
an ability of the student to learn new concepts in a particular discipline;
a favored style of learning of the student;
a chronological age of the student; and
an academic age of the student.

19. The system of claim 15, wherein assessing the student includes at least one of:
identifying a priori knowledge for the concept portion;
identifying gaps in a priori knowledge of the student associated with the concept portion; and
supplementing explanation information to address identified knowledge deficits.

20. The system of claim 15, further comprising editing the explanation submission prior to evaluating the explanation submission.
